(19) United States
(12) Patent Application Publication
(10) Pub. No.: US 2022/0310986 A1
(43) Pub. Date: Sep. 29, 2022

(54) METHOD AND DEVICE FOR FORMING BUNDLES OF NANOFILAMENTS

(71) Applicant: AIXTRON SE, Herzogenrath (DE)

(72) Inventors: Bernd SCHINELLER, Aachen (DE); Kenneth B. K. TEO, Cambridge (GB); Nalin Lalith RUPESINGHE, Cambridge (GB)

(21) Appl. No.: 17/805,369

(22) Filed: Jun. 3, 2022

Related U.S. Application Data
(63) Continuation of application No. 16/336,437, filed on Mar. 25, 2019.

(30) Foreign Application Priority Data
Sep. 29, 2016 (DE) 10 2016 118 404.7

(51) Int. Cl. H01M 4/04; H01M 4/36; H01M 4/38; H01M 4/583; H01M 4/66

(52) U.S. Cl. CPC H01M 4/0419; H01M 4/366; H01M 4/386; H01M 4/583; H01M 4/663; B82Y 30/00

(57) ABSTRACT

A device can be used as an electrode for a lithium-ion battery. The device comprises an electrically conductive substrate to the surface of which nanofilaments having an ion-absorbing coating are applied. The nanofilaments are combined by the application of light into a plurality of bundles, each having multiple nanofilaments. A spacer gap is formed between neighboring bundles.

### RELATED APPLICATIONS

This application is a Continuation Application of U.S. application Ser. No. 16/336,437, filed on 25 Mar. 2019, which is a National Stage under 35 USC 371 of and claims priority to International Application No. PCT/EP2017/074183, filed 25 Sep. 2017, which claims the priority benefit of DE Application No. 10 2016 118 404.7, filed 29 Sep. 2016.

### FIELD OF THE INVENTION

The invention pertains to a device that can be used as an electrode, particularly for a lithium-ion battery, and comprises an electrically conductive substrate, to the surface of which nanofilaments having an ion-absorbing coating are applied.

The invention furthermore pertains to a method for producing such an electrode.

The invention furthermore pertains to a battery that comprises at least one such electrode.

The invention furthermore pertains to a device for carrying out the method.

### BACKGROUND

U.S. Pat. No. 8,420,258 B2 describes an electrode for use on a lithium-ion battery.

A lithium-ion battery essentially consists of two volumes, which are separated from one another by a porous partition wall and in which an electrolyte containing lithium ions is accommodated. The cathode, which may consist of copper, has tree-like carbon nanotubes that are coated with silicon. The silicon layer forms an ion-absorbing coating, in which lithium cations can be absorbed such that its volume simultaneously increases.

US 2013/0244107 A1 describes an electrically conductive substrate for electrodes for lithium-ion batteries. Filaments consisting of carbon, to which a silicon layer is applied, are located on the surface of the substrate. The filaments have an ion-absorbing function.

US 2012/0126449 A1 describes a method for bundling carbon nanotubes, which on statistical average are uniformly arranged over the surface of a substrate. Bundles of nanofilaments are formed due to capillary forces by wetting and subsequently drying the nanofilaments. In this case, multiple directly adjacent nanofilaments contact one another with their free ends. A clearance is formed between two directly adjacent bundles.

U.S. Pat. Nos. 8,540,922 B2 and 9,064,614 B2 describe methods, by means of which carbon nanotubes (CNT) are deposited on an electrically conductive substrate and structures are produced by means of a laser beam. The laser beam is intended to break up chemical bonds such that gaps are cut into the uniform surface distribution of the nanofilaments.

In the production of electrodes for lithium-ion batteries, silicon has the advantage that it can absorb about ten-times more lithium per volume than carbon. However, a coating with monocrystalline or polycrystalline silicon has the disadvantage that the layer is destroyed after several charging cycles because the absorption of lithium ions is associated with a volume increase.

Methods for bundling CNTs are furthermore described in the PNAS articles “Capillarity-driven assembly of two-dimensional cellular carbon nanotube foams,” Mar. 23, 2004/Vol. 101/No. 12/4009-4012, and “Behavior of fluids in nanoscopic space,” Apr. 27, 2004/Vol. 101/No. 17/6331-6332.

### SUMMARY OF THE INVENTION

The invention is based on the objective of disclosing a technically enhanced electrode, a battery provided with the electrode, a method or a process step for producing the electrode and a device for producing the electrode.

It is initially and essentially proposed that the nanofilaments are combined into a plurality of bundles, which respectively comprise multiple nanofilaments. Each bundle contains nanofilaments, a fixed end of which is connected to the electrically conductive substrate and the free end of which rests against the free ends of adjacent nanofilaments. This results in the formation of corn shock-like structures, which in a top view of the surface coated with the nanofilaments have a circular or linear shape and are separated from one another by clearances. The filigree outer walls of the bundles are provided with the ion-absorbing coating during the coating process. The nanofilaments preferably are carbon nanotubes. The cross-sectional distance through a bundle measured in the top view, i.e. the diameter of a circle-equivalent base area, may lie between 0.5 and 5 μm. The cross-sectional distance through a bundle preferably lies between 1.5 and 2.5 μm. Adjacent bundles are spaced apart from one another by about 1.5 to 2.5 μm in the region of the free ends of the nanofilaments. In the region of the free ends, the cross-sectional distance through a bundle amounts to less than half of the length of the cross-sectional distance in the region of the fixed ends of the filaments of a bundle. The ion-absorbing coating particularly is a coating with nanoparticles. These nanoparticles can be sprayed into the clearances between the bundles. The nanoparticles particularly may consist of silicon particles, sulfur particles, titanium oxide particles or 3D metal particles. In the method for producing an inventive electrode, a substrate is initially supplied, wherein said substrate may be realized in the form of a metal substrate, e.g. an aluminum foil or copper foil. A layer of nanofilaments is applied to this substrate. This preferably takes place in a CVD process, wherein said process is a growth process, in which the nanofilaments that preferably consist of carbon nanotubes grow away from the surface of the substrate such that the resulting arrangement of nanofilaments is on statistical average uniform over the surface. To this end, the device used for carrying out the method comprises a first coating station, which may be realized in the form of a CVD reactor. The nanofilaments are combined into bundles in the next step, which takes place in a forming station of the processing device. The inventors of the present application have discovered the surprising effect that nanofilaments combine into bundles due to the application of light. In a preferred method, bundling is therefore realized by using light, to which the nanofilaments are exposed. The light may be generated by a lamp, particularly a xenon lamp. The light may also be generated by a laser. The laser may consist of a pulsed laser or a continuously operating laser. It may be realized in the form of a xenon laser, a diode laser, a gas laser, an infrared laser, an UV laser or an excimer laser. If the light is generated by a laser beam, the laser beam preferably is expanded. The expansion may be a linear expansion. The light and particularly the laser beam move over the layer with a preferably constant speed such that the free ends of the filaments can connect to one another and form bundles. An ion-absorbing coating is applied to the bundles in the next step, which is carried out in a coating station of the processing device. Nanoparticles preferably are used for this purpose. The nanoparticles, which preferably consist of silicon particles, may be sprayed on the surface of the substrate in wet or dry form. To this end, the processing device preferably comprises a nozzle arrangement, e.g. a spraying device. The nanoparticles applied to the bundles can be connected to one another and/or to the nanofilaments in another process step. This preferably takes place in the second coating station. To this end, the second coating station may comprise a light source, a heater or another energy application device, by means of which the nanoparticles are sintered to one another and/or to the nanofilaments lying underneath the nanoparticles. The coating station preferably comprises a laser, which generates an expanded laser beam that moves over the substrate with a constant speed. In a preferred variation, the processing device comprises a plurality of processing stations that are arranged directly behind one another in a transport direction of the substrate, wherein the substrate is unwound from a roll and continuously passes through said processing stations. The electrode produced in this continuous process is wound up on a second roll. An electrode coated with silicon particles can be used as an anode and an electrode coated with another material, e.g. sulfur or titanium oxide, can be used as a cathode for a lithium-ion battery. The length of the individual nanofilaments may lie between 20 μpm and 200 μm. The diameter of the individual nanofilaments may lie in the range between 1 nm and 200 nm, preferably between 5 nm and 100 nm. The deposition, particularly of carbon nanotubes, takes place in a self-organizing system on the conductive substrate. However, it is also possible to deposit the carbon nanotubes on a substrate that is pre-structured with a seed structure, e.g. with seed particles. An essentially continuous forest of adjacently arranged carbon nanotubes preferably is produced in this process step. These carbon nanotubes are then combined into bundles in another process step, particularly due to the application of light. The typical diameters of the bundles lie between 200 nm and 10 μm. The nanoparticles, with which the bundled nanofilaments are coated, have characteristic diameters in the range between 1 nm and 500 nm, preferably between 20 nm and 200 nm. The nanofilaments preferably are applied to the substrate with 5 g/m² to 50 g/m². The laser power, with which the xenon laser is operated, lies between approximately 1 mJ and 100 mJ. During the treatment of the nanoparticles with a laser beam, their surfaces melt such that adjacent nanoparticles connect by fusing their surfaces to one another and/or to the bundles of nanofilaments. A process chamber, within which the coating process can be carried out under a total pressure of 100 mbar to 1100 mbar, preferably is used as first coating station. Argon, nitrogen or hydrogen typically is used as inert gases. The CNT deposition preferably takes place at 200° C. to 1000° C. The coating of the bundles with silicon nanoparticles takes place at temperatures between room temperature and 250° C., preferably at temperatures between room temperature and 150° C. The laser light may be generated within the device. The laser light can also be transmitted from a remote laser to the device by means of fiber-optic cables. The nanoparticles preferably can be applied to the nanofilaments in dry form. In addition to Si, SiO₂, TiO₂, CrO₂, S, LiCoO, LiTiO, LiNiO, LiMnO, LiFePO, LiCoPO, LiMnPO, V₂O₅, Ge, Sn, Pb and ZnO may also be considered as nanoparticles.

The invention furthermore pertains to a method for bundling nanofilaments applied to a substrate. The bundling is realized by applying energy in the form of light to the nanofilaments, wherein the light not only comprises the visible portion of the spectrum, but also the adjacent ultraviolet portions and infrared portions of the spectrum.

The invention furthermore pertains to a device for carrying out a method for producing an electrode of the type described in U.S. Pat. No. 8,420,258 B2. An electrically conductive substrate, which may consist of an uncoated or pre-coated metal foil, is transported through the device in a transport direction with the aid of transport means. The substrate can be unwound from a first roll and wound up again on a second roll. The device, through which the substrate is transported, is located between the two rolls. The device comprises a processing device, in which the following processing stations are successively arranged in the transport direction: a first coating station, in which the nanofilaments are applied to the substrate. This coating station may comprise a CVD process chamber, in which the nanofilaments are deposited on the substrate. A forest of nanofilaments, which essentially are uniformly distributed over the surface of the substrate, is formed in this deposition process. However, it is also possible to limit the growth of the nanofilaments to structured regions, e.g. zones that are spaced apart from one another, with the aid of a seed structure that was previously deposited on the substrate. For example, the zones may be realized in the form of uniformly distributed islands. The nanofilaments deposited on the substrate particularly may be individually standing nanofilaments. The deposited nanofilaments may be spaced apart from one another sufficiently far for not contacting one another. In the next step, the above-described coating is applied to the nanofilaments in a second coating station. In this case, nanoparticles, particularly silicon particles, initially are applied to the nanofilaments. This may be realized with a spraying device, by means of which the nanoparticles are introduced into a process chamber in dry form with a gas stream or in liquid form with a liquid stream, namely with the aid of a nozzle arrangement. The substrate coated with the nanofilaments is transported through the process chamber. The nanoparticles are deposited on the nanofilaments in the process. In the next step, the nanoparticles can be sintered to one another and to the nanofilaments. This is realized by applying energy, wherein the energy is sufficiently high for preferably melting the nanoparticles on their surface such that they can connect to adjacent nanoparticles and to the filaments. A laser or another light source, as well as a heater such as a radiant heater, may be used as energy source. The individual stations, namely the first coating station, a nanoparticle application station and a melting station, may be arranged directly behind one another in the transport direction. They may be arranged in a common housing. However, they may also be arranged in housings that are separated from one another. Gas-flushed gates may be provided between the individual separated housings.

The substrate may be provided with the above-described structures on only one of its two opposite broad sides. However, it is also proposed to provide the substrate with the above-described structures on both sides. The application of the structures may take place simultaneously on both broad sides. However, it is also proposed to apply the structures to the two broad sides successively.

### BRIEF DESCRIPTION OF THE DRAWINGS

The invention is described in greater detail below with reference to exemplary embodiments. In the drawings:

FIG. 1 schematically shows a process sequence for producing the inventive electrode,

FIG. 2 shows a schematic representation of a first exemplary embodiment of a device for carrying out the method,

FIG. 3 shows a second exemplary embodiment of a device,

FIG. 4 shows a third exemplary embodiment of a device,

FIG. 5 shows a representation according to FIG. 1 concerning a second exemplary embodiment of a method and a device for producing an electrode,

FIG. 6 shows another exemplary embodiment of a device for carrying out the method schematically illustrated in FIG. 5, and

FIG. 7 schematically shows a cell of a lithium-ion battery.

### DETAILED DESCRIPTION

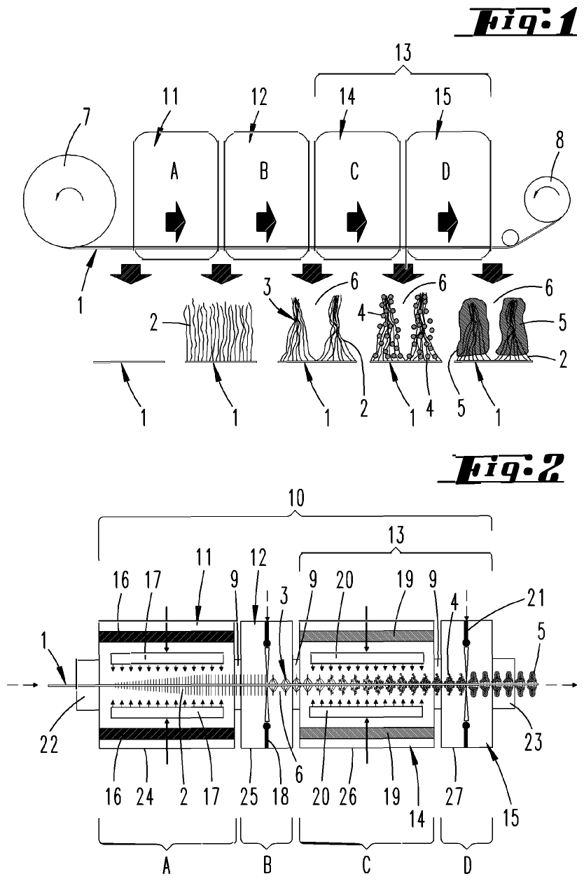

FIG. 1 schematically shows the process sequence for producing an electrode for a lithium-ion battery. A thin metallic substrate, e.g. in the form of an aluminum foil or preferably a copper foil, is unwound from a first roll 7 and coated with a microstructure in four successive process steps A, B, C, D. The coated substrate 1 is then wound up again on a second roll 8.

The substrate 1 is coated with carbon nanotubes 2 in a first process step A. The nanotubes 2 have a fixed end that is rigidly connected to the substrate 1 and a free end that essentially points away from the substrate 1. The coating process takes place in a first coating station 11.

The second process step B is carried out in a forming station 12 that is arranged downstream of the coating station 11 referred to a transport direction of the substrate 1. Light energy is applied to the layer of nanofilaments, which was deposited on the substrate in the first process step A, by means of the laser beam of a xenon laser. This exposure to light surprisingly causes the nanofilaments 2 to combine in a bundle-like manner. The free ends of the nanofilaments 2, which essentially are uniformly arranged on the surface of the substrate 1, orient themselves into closely adjacent bundles 3 such that clearances 6 are formed between adjacent bundles 3. The length of the bundles 3 measured in the direction, in which the nanofilaments 2 extend, is greater than a cross-sectional distance through the bundle 3 in the region of the fixed ends of the nanofilaments 2. In the region of the free ends of the nanofilaments 2, in which the bundles 3 are in contact with adjacent nanofilaments 2, a characteristic cross-sectional length has a value of less than half of the cross-sectional length of the bundle in the region of the fixed ends of the nanofilaments 2.

In a third process step C, silicon nanoparticles 4 are sprayed on the bundles with a dry or wet spraying method in a nanoparticle application station 14. The silicon nanoparticles 4 partially penetrate into the bundles 4 and into the intermediate spaces between the bundles.

The nanoparticle application station 14 forms part of a second coating station 13 that also serves for carrying out a fourth process step D, in which the nanoparticles 4 applied to the bundles 3 are sintered to one another. To this end, energy is applied to the bundles 3 sprayed with nanoparticles 4 in a melting station 15. The energy preferably is applied to the bundles 3 in the form of light, wherein the light may be infrared light, visible light or UV light. However, it is also possible to apply energy in the form of heat. In the fourth process step D, the nanoparticles 4 are fused with one another by means of the applied radiant energy.

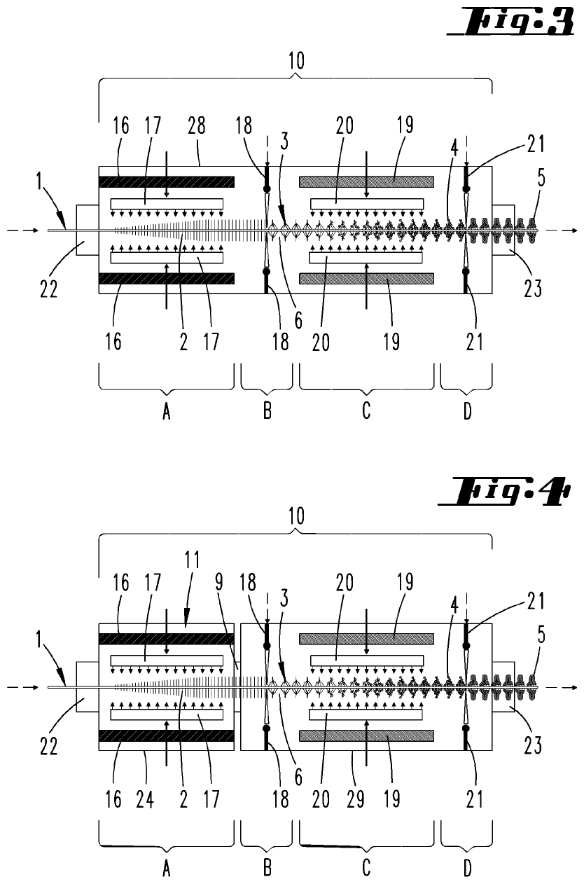

FIG. 2 shows a first exemplary embodiment for carrying out the method, wherein a substrate 1 is coated with nanofilaments 2 on both sides in this case. To this end, the device comprises an entry arrangement that may be realized in the form of a gas-tight gate, through which the substrate 1 is transported into the device 10. The device comprises a first coating station 11 that is arranged in a housing 24. The housing contains two heaters 16, by means of which a process chamber of the coating station 11 is heated to a process temperature. A gas inlet element 17 is located in the process chamber on each side of the flat, electrically conductive substrate 1, wherein process gases are fed into the process chamber through said gas inlet elements. Nanofilaments 2 grow on the substrate 1, which is continuously transported through the coating station 11, due to a pyrolytic reaction. A heater 16 and a gas inlet element 17 are respectively located on both opposite sides of the substrate 1 such that the substrate 1 is coated on both sides.

The substrate 1 provided with the nanofilaments 2 is transported into another housing 25, which is assigned to a forming station 12, through a gas-flushed gate 9. The housing 25 contains two laser arrangements that apply light energy to both opposite broad sides of the electrically conductive substrate 1, which are respectively coated with nanofilaments 2. The light originates from a xenon lamp or a laser and has such an intensity that the nanofilaments 2 self-orient into bundles 3 due to the application of energy in the form of the laser light. In the process, bundles 3 of the type described in initially cited articles “Behavior of fluids in nanoscopic space” or “Capillarity-driven assembly of two-dimensional cellular carbon nanotube foams” are formed.

The electrically conductive substrate 1 is transported into a second coating station 13 through another gas-flushed gate 9. In the exemplary embodiment illustrated in FIG. 2, the second coating station 13 consists of a nanoparticle application station 14 and a melting station 15 arranged downstream thereof. The coating station 13 comprises a housing 26.

The nanoparticle application station 14 comprises heaters 19 that are arranged on both sides of the substrate just like the heaters 16. A process chamber of the nanoparticle application station 14 is heated to a temperature between room temperature and 250° C. by means of these heaters.

The process chamber furthermore comprises spray nozzles 20 or a gas inlet element 20, by means of which nanoparticles 4 can be transported into the process chamber in the direction of a broad face of the substrate 1, particularly with the aid of a carrier gas. The nanoparticles 4 respectively deposit on the bundles 3 of nanofilaments 2 and reach the interior of the bundles 3. A loose bond containing cavities is formed between the nanoparticles 4 and the nanofilaments 2. The heaters 19 and the spray nozzles 20 are arranged in the same housing 26.

The thusly prepared substrate 1 is transported into the melting station 15 through another gas-flushed gate 9, wherein both broad sides of the substrate 1 are in said melting station exposed to the laser light of a laser 21 or the light of a xenon lamp in such a way that adjacent nanoparticles 4 fuse with one another and/or that nanoparticles 4 connect to the nanofilaments 2. A porous body with a plurality of cavities, which is capable of absorbing lithium ions in solution, is formed in the process. The melting station 15 comprises a separate housing 27.

The exemplary embodiment illustrated in FIG. 2 comprises three housings 24, 25, 26, 27, which are arranged behind one another in the transport direction of the electrically conductive substrate 1, wherein one of the four processing steps A, B, C, D is carried out in each of the housings 24, 25, 26, 27. The housings 24, 25, 26, 27 are connected to one another by means of gas-flushed gates 9.

FIG. 3 shows a second exemplary embodiment of the invention, in which all processing stations are arranged in one housing. The heaters 16, the gas inlet elements 17, the xenon laser 18, the heating elements 19 and the spraying device 20 are accommodated in a common housing together with the laser 21. Only the entry arrangement 22 and the exit arrangement 23 form gas-flushed gates, through which the substrate 1 is transported into the device 10 and once again transported out of the device 10.

In the exemplary embodiment illustrated in FIG. 4, the device 10 consists of two housing parts that are connected to one another by means of a gas-flushed gate 9. The first processing step A is carried out in a housing 16 and the second, third and fourth processing steps B, C, D are carried out in a second housing 29.

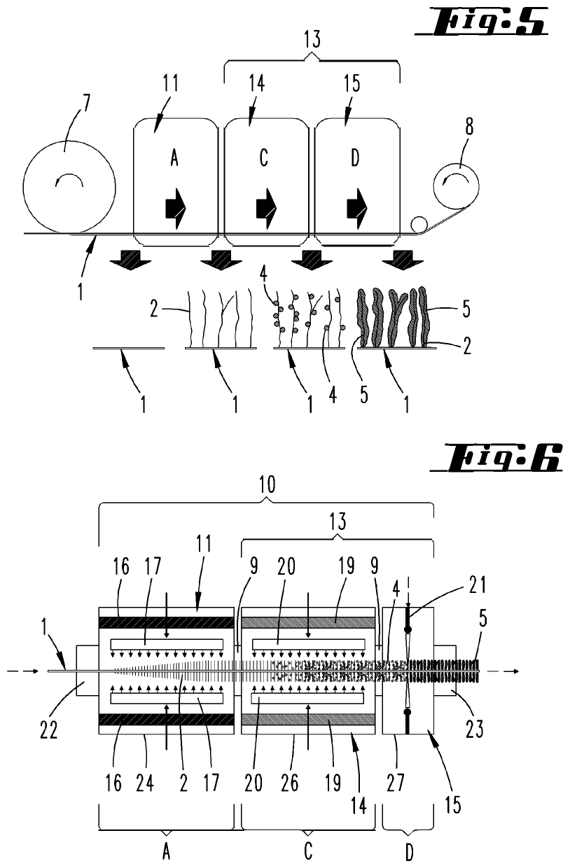

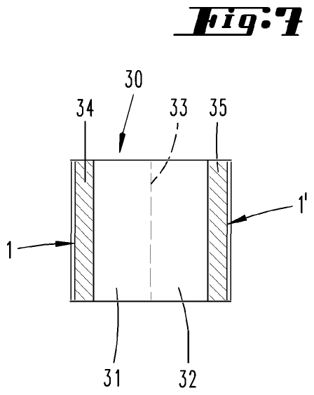

FIGS. 5 and 6 show a variation of a system for producing an electrode of a lithium-ion cell including a method, in which an electrically conductive substrate 1 is unwound from a first roll 7. Nanofilaments 2 are deposited on the substrate 1 in a process step A. Nanoparticles 4 are applied to the nanofilaments 2 in a process step C. The nanoparticles 4 are fused into a coating 5 in a process step D. The nanoparticles also connect to the nanofilaments 2 in the process. The substrate 1 may be pre-treated. For example, its surface may be provided with a seed structure, by virtue of which nanofilaments 2 only grow on predefined zones of the substrate 1. The zones may consist of island-like microzones that are uniformly distributed over the broad face and separated from one another by a clearance.

The nanofilaments 2 deposited in process step A particularly may also be individually standing nanofilaments. They may be spaced apart from one another so far that adjacent nanofilaments 2 do not contact one another. They may also be realized in the form of ramified nanofilaments 2.

The device required for carrying out this method may also comprise all processing stations of the devices illustrated in FIGS. 2-4 except for the forming station 12. The invention particularly pertains to a device of the type illustrated in FIG. 6. An entry arrangement 22 is provided, through which the electrically conductive substrate enters the device 10. The electrically conductive substrate 1 once again exits the device through an exit arrangement 23. The entry arrangement 22 and the exit arrangement 23 may be gas-flushed gates. A coating station is arranged adjacently downstream of the entry arrangement 22 referred to a transport direction, in which the substrate 1 is transported. The coating station 11 comprises a housing 24 that contains two heaters 16 and two gas inlet elements 17 arranged between the heaters. The electrically conductive substrate 1 is transported through the intermediate space between the two gas inlet elements 17.

A gas-flushed gate 9, through which the substrate 1 is transported, is arranged adjacently downstream of the housing 24.

Another housing 26 is arranged adjacently downstream of the gas-flushed gate 9. However, the housing 26 may also be directly connected to the housing 24.

Two heaters 19 are arranged in the housing 26. Two nozzle arrangements 20 are located between the two heaters 19. The substrate 1 is transported through the space between the two nozzle arrangements 20. The housing 26 contains the above-described nanoparticle application station 14.

A gas-flushed gate 9, through which the substrate is transported, is arranged adjacently downstream of the housing 26. An additional housing 27 is arranged adjacently downstream of the gas-flushed gate 9 and contains a melting station 15 that comprises a laser 21. However, the housing 27 may also be directly connected to the housing 26.

Energy is applied to both sides of the substrate 1 in the melting station 15 by means of a laser beam 21 such that the nanoparticles 4, which were deposited on the filaments 2 in the nanoparticle application station 14, connect to one another and/or to the nanofilaments 2.

The exit arrangement 23 is arranged directly downstream of the housing 27.

In the latter method and in the device for carrying out this method, the nanoparticles 4 are directly applied to the nanofilaments 2. Prior bundling of the nanofilaments 2 is not carried out in this case.

In variations that are not illustrated in the drawings, only one side of the substrate 1 is provided with the above-described filament layer that is coated with nanoparticles 4. In this case, the correspondingly used device only comprises the elements that are illustrated above or underneath the substrate 1 in the drawings. However, two such devices would also make it possible to provide both sides of the substrate 1 with nanofilaments 2 that are coated with nanoparticles, namely by initially providing a first broad face of the substrate 1 and subsequently providing the second broad face of the substrate 1 with filaments 2 that are coated with nanoparticles.

The inventive method makes it possible to produce an electrode 34, 35 of the type used in a lithium-ion cell in the inventive device, wherein such a lithium-ion cell is schematically illustrated in FIG. 7. Two electrodes 34, 35 are located on opposite sides of a battery cell 30. A porous wall 33 is located between the electrodes 34, 35. An electrolyte containing lithium ions is accommodated in the volumes 31, 32.

According to the invention, the nanofilaments 2, which are initially applied to the substrate 1 in a uniformly distributed and essentially structureless manner, are combined into bundles 3. In this case, a group of directly adjacent nanofilaments 2 is directed at a common center. Adjacent bundles respectively comprise nanofilaments 2 that are directed at a common center such that the nanofilaments 2 of adjacent bundles are directed away from a clearance located between multiple bundles 3.

In the next production step, the bundles 3 are provided with a coating of silicon nanoparticles 4. In this case, each respective bundle 3 may be provided with such a coating, wherein the coatings of silicon nanoparticles are spaced apart from one another.

The preceding explanations serve for elucidating all inventions that are included in this application and also respectively enhance the prior art independently with at least the following combinations of characteristic features, namely:

A device, which is characterized in that the nanofilaments are combined into a plurality of bundles, which respectively comprise multiple nanofilaments, wherein a clearance 6 is formed between adjacent bundles 3.

A method comprising at least the following process steps:
supplying an electrically conductive substrate 1;
applying a layer of nanofilaments 2, which on statistical average are uniformly arranged over the surface of the substrate 1;
respectively combining a plurality of nanofilaments into bundles 3 such that a clearance 6 remains between adjacent bundles 3;
applying an ion-absorbing coating 5 to the bundles 3.

A method, which is characterized in that the nanofilaments 2 are exposed to light.

A device or a method, which is characterized in that the nanofilaments 2 are carbon nanotubes CNT.

A device or a method, which is characterized in that a cross-sectional distance through a bundle 3 respectively lies between 0.5 and 5 μm or between 1.5 and 2.5 μm.

A device or a method, which is characterized in that the ion-absorbing coating 5 is formed by nanoparticles 4, which are connected to one another and to the bundles of nanofilaments 2.

A device or a method, which is characterized in that the nanoparticles 4 comprise silicon, sulfur, titanium oxide, a phosphite, a nitrite or carbon and, in particular, SiO₂, TiO₂, CrO₂, S, LiCoO, LiTiO, LiNiO, LiMnO, LiFePO, LiCoPO, LiMnPO, V₂O₅, Ge, Sn, Pb or ZnO.

A method, which is characterized in that the nanofilaments 2 applied to the substrate 1 are formed into bundles 3 by being exposed to light.

A method, which is characterized in that the layer of nanofilaments 2 is exposed to the light of a xenon lamp or a laser.

A method, which is characterized in that a laser beam, which is generated continuously or in a pulsed manner and expanded into a strip, is used for exposing the layer of nanofilaments 2 to light, wherein the laser beam preferably moves over the layer with a constant speed.

A method, which is characterized in that silicon nanoparticles 4 are applied, particularly sprayed, onto the bundles 3 during the application of the coating 5, wherein said silicon nanoparticles are connected to one another and to the nanofilaments 2 lying underneath the nanoparticles by applying energy thereto.

A method, which is characterized in that light, particularly the light of a laser beam, is used for connecting the nanoparticles 4 to one another and/or to the bundles of nanofilaments 2 lying underneath the nanoparticles, wherein said light moves over the surface of the substrate such that at least the surface of the nanoparticles 4 melts.

A battery, which is characterized in that the first and/or second electrode 34, 35 is realized in accordance with one of the preceding characteristic features.

A device, in which at least the following processing stations of the processing device 10 are arranged directly behind one another in the transport direction:
a first coating station 11, in which nanofilaments 2 are applied to the substrate 1;
a second coating station 13, in which the nanofilaments 2 are provided with an ion-absorbing coating 5.

A device, which is characterized in that a forming station 12, in which the nanofilaments 2 are combined into bundles 3, is provided between the first coating station 11 and the second coating station 13, wherein said bundles 3 are provided with a coating 5 in the second coating station 13.

A device, which is characterized in that a first roll 7 is provided, on which the substrate 1 is wound up, wherein said substrate passes through the processing device 10 from the entry arrangement 22 to the exit arrangement 23 and is wound up on a second roll 8 downstream of the exit arrangement 23 referred to the transport direction.

A device, which is characterized in that the forming station 12 comprises a light source 18, particularly a laser, by means of which the layer of nanofilaments 2 applied to the substrate 1 in the first coating station 11 can be exposed to light in such a way that a plurality of nanofilaments 2 combine into bundles 3.

A device, which is characterized in that the second coating station 13 comprises a spraying device 20, by means of which nanoparticles 4 can be sprayed on the bundles 3 produced in the forming station.

A device, which is characterized in that the second coating station 13 comprises a light source 21, particularly a laser, by means of which the nanoparticles 4 applied to the bundles 3 or nanofilaments 2 are connected to one another and to the nanofilaments 2.

All disclosed characteristic features are essential to the invention (individually, but also in combination with one another). The disclosure content of the associated/attached priority documents (copy of the priority application) is hereby fully incorporated into the disclosure of this application, namely also for the purpose of integrating characteristic features of these documents into claims of the present application. The characteristic features of the dependent claims characterize independent inventive enhancements of the prior art, particularly for submitting divisional applications on the basis of these claims.

### LIST OF REFERENCE SYMBOLS

1 Electrically conductive substrate
2 Nanofilament
3 Bundle
4 Nanoparticle
5 Coating
6 Clearance
7 First roll
8 Second roll
9 Gas-flushed gate
10 Device
11 Coating station
12 Forming station
13 Coating station
14 Nanoparticle application station
15 Melting station
16 Heater
17 Gas inlet element
18 Laser
19 Heater
20 Spray nozzles
21 Laser
22 Entry arrangement
23 Exit arrangement
24 Housing
25 Housing
26 Housing
27 Housing
28 Housing
29 Housing
20 Battery cell
31 Volumes
32 Volumes
33 Porous wall
34 Electrode
35 Electrode
A Process step/nanofilament growth
B Process step/forming
C Process step/nanoparticle application
D Process step/sintering

1. A method, comprising:
uniformly arranging nanofilaments (2) over a surface of an electrically conductive substrate (1), wherein each of the nanofilaments (2) has a fixed end connected to the electrically conductive substrate (1) and a free end; and
exposing the nanofilaments (2) to light from a first light source (18) of such an intensity that the light causes the respective free ends of a plurality of adjacent nanofilaments (2) to abut each other so as to form bundles (3) of nanofilaments (2), wherein the bundles (3) are separated from one another by spaces.

2. The method of claim 1, wherein the nanofilaments (2) are carbon nanotubes (CNT).

3. The method of claim 1, wherein a cross-sectional distance through one of the bundles (3) is between 0.5 and 5 μm.

4. The method of claim 1, further comprising applying an ion-absorbing coating (5) to the bundles (3), the ion-absorbing coating (5) comprising nanoparticles (4) that are connected to one another and to the bundles (3).

5. The method of claim 4, wherein the nanoparticles (4) comprise at least one of silicon, sulfur, titanium oxide, a phosphite, a nitrite, carbon, SiO₂, TiO₂, CrO₂, LiCoO, LiTiO, LiNiO, LiMnO, LiFePO, LiCoPO, LiMnPO, V₂O₅, Ge, Sn, Pb or ZnO.

6. The method of claim 1, wherein the first light source (18) comprises a xenon lamp or a laser.

7. The method of claim 1, wherein the light from the first light source (18) comprises a laser beam that is generated continuously or in a pulsed manner and expanded into a strip, the method further comprising moving the laser beam over the nanofilaments (2) at a constant speed.

8. The method of claim 4, further comprising:
applying silicon nanoparticles (4) onto the bundles (3) during the application of the ion-absorbing coating (5); and
applying energy to the silicon nanoparticles (4) so as to connect the silicon nanoparticles (4) to one another and to the bundles (3).

9. The method of claim 8, wherein light from a second light source (21) is used for connecting the silicon nanoparticles (4) to one another and to the bundles (3), the method further comprising moving the light from the second light source (21) over the surface of the electrically conductive substrate (1) so as to melt a surface of the silicon nanoparticles (4).

10. A device, comprising:
a processing device (10) comprising:
a first coating station (11) configured to form nanofilaments (2) on a substrate (1), wherein the substrate (1) is electrically conductive; and
a forming station (12) arranged directly behind the first coating station (11) in a transport direction, wherein the forming station (12) comprises a first light source (18) for exposing the nanofilaments (2) on the substrate (1) to light in such a way that the nanofilaments (2) combine into bundles (3) of nanofilaments (2);
an entry arrangement (22) for supplying the substrate (1) into the processing device (10);
an exit arrangement (23) for removing the substrate (1) from the processing device (10); and
transport means for transporting the substrate (1) through the processing device (10) in the transport direction from the entry arrangement (22) to the exit arrangement (23).

11. The device of claim 10, wherein the processing device (10) further comprises a second coating station (13) for applying a coating (5) on the bundles (3) formed in the forming station (12).

12. The device of claim 10, further comprising:
a first roll (7) on which a first portion of the substrate (1) is wound; and
a second roll (8) on which a second portion of the substrate (1) is wound,
wherein the first roll (7) is disposed upstream from the entry arrangement (22) with respect to the transport direction, and the second roll (8) is disposed downstream of the exit arrangement (23) with respect to the transport direction.

13. The device of claim 10, wherein the first light source (18) comprises a laser.

14. The device of claim 11, wherein the second coating station (13) comprises a spraying device (20) for spraying nanoparticles (4) on the bundles (3) produced in the forming station (12).

15. The device of claim 14, wherein the second coating station (13) comprises a second light source (21) for shining light onto the nanoparticles (4) sprayed on the bundles (3) so as to connect the nanoparticles (4) to one another and to the bundles (3).
